(19) United States
(12) Patent Application Publication
(10) Pub. No.: US 2004/0101088 A1
(43) Pub. Date: May 27, 2004

(54) Methods and apparatus for discriminating multiple contrast agents

(76) Inventors: John Michael Sabol, Sussex, WI (US); Matthew Joseph Walker, New Berlin, WI (US); Gopal B. Avinash, New Berlin, WI (US)

Correspondence Address: John S. Beulick, Armstrong Teasdale LLP, Suite 2600, One Metropolitan Sq., St. Louis, MO, 63102, US

(21) Appl. No.: 10/306,466

(22) Filed: Nov. 27, 2002

(51) Int. Cl. G21K 1/12

(52) U.S. Cl. 378/4

(57) ABSTRACT

A method for discriminating multiple contrast agents using a medical imaging system includes introducing a first contrast agent into a first vessel, introducing a second contrast agent different from the first contrast agent into a second vessel different from the first vessel, acquiring a plurality of projection data of an area of interest in flow communication with the first vessel and the second vessel, and decomposing the projection data into a first density map representative of the first contrast agent and a second density map representative of the second contrast agent.

### BACKGROUND OF THE INVENTION

This invention relates generally to medical imaging systems and more particularly to an apparatus and methods for discriminating multiple contrast agents using a medical imaging system.

In spite of recent advancements in computed tomography (CT) technology, such as faster scanning speeds, larger coverage with multiple detector rows, and thinner slices, energy resolution is still a missing piece. Namely, wide x-ray photon energy spectrum from the x-ray source and the lack of energy resolution from CT detection systems preclude energy discrimination CT.

X-ray attenuation through a given object is not a constant. Rather, the X-ray attenuation is strongly dependent on the x-ray photon energy. This physical phenomenon manifests itself in the image as beam-hardening artifacts, such as, non-uniformity, shading, and streaks. Some beam-hardening artifacts can be easily corrected, but other beam-hardening artifacts may be more difficult to correct. In general, known methods to correct beam hardening artifacts include water calibration, which includes calibrating each CT machine to remove beam hardening from materials similar to water, and iterative bone correction, wherein bones are separated in the first-pass image then correcting for beam hardening from the bones in the second-pass. However, beam hardening from materials other than water and bone, such as metals and contrast agents, may be difficult to correct. In addition, even with the above described correction methods, conventional CT does not provide quantitative image values. Rather, the same material at different locations often shows different CT numbers.

Another drawback of conventional CT is a lack of material characterization. For example, a highly attenuating material with a low density can result in the same CT number in the image as a less attenuating material with a high density. Thus, there is little or no information about the material composition of a scanned object is based solely on the CT number.

Additionally, assessment of the vasculature is often difficult since the images produced by such scanners may exhibit a significant level of image artifacts and CT number inaccuracy. These limitations may prevent the utilization of the CT device for advanced diagnosis. For example, some organs and tissues within the body are perfused by collateral blood supplies. While this represents a good engineering design, often it can make assessment of the vasculature and perfusion of the organ or tissue difficult. Typically, perfusion is assessed by imaging the temporal distribution of an injected contrast agent as it moves through the vasculature. In cases of collateral flow, assessment of the viability of the collateral blood supply or tissue perfusion can be difficult since the operator often cannot tell the origin of contrast agent that is perfusing the organ. One example of a collateral blood supply is in the Circle of Willis. The Circle of Willis is a loop of blood vessels positioned along an undersurface of a brain between the brain and the skull base. Oxygenated blood enters the Circle of Willis from both the right and left carotid arteries. The blood travels around the circle, mixing and is distributed to the brain through the cerebral arteries. Due to the turbulent flow, the Circle of Willis is a common site for aneurysms, typically forming at the junctions with other arteries. Other common pathologies include incomplete, or partially blocked vessels forming in the Circle of Willis. Another example of an organ with collateral vascular supply is the ovary. Approximately 56% of all women have two sources of blood supplied to the ovaries, the ovarian and uterine arteries, but approximately 44% are only served by one of the arteries. Assessment of both vasculatures is beneficial in the planning of tubal ligation procedures, because, patients with an ovary perfused by only one source, care should be taken to ensure that the remaining vessel is not impaired.

### BRIEF DESCRIPTION OF THE INVENTION

In one aspect, a method for discriminating multiple contrast agents using a medical imaging system is provided. The method includes introducing a first contrast agent into a first vessel, introducing a second contrast agent different from the first contrast agent into a second vessel different from the first vessel, acquiring a plurality of projection data of an area of interest in flow communication with the first vessel and the second vessel, and decomposing the projection data into a first density map representative of the first contrast agent and a second density map representative of the second contrast agent.

In another aspect, a method for discriminating multiple contrast agents using a medical imaging system is provided. The method includes introducing a first contrast agent into a first vessel, introducing a second contrast agent into a second vessel, the first contrast agent different than the second contrast agent, the first vessel different than the second vessel, acquiring a plurality of projection data of an area of interest in flow communication with the first vessel and the second vessel, and decomposing the projection data into a first density map representative of the first contrast agent and a second density map representative of the second contrast agent.

In a further aspect, a method for discriminating between a contrast agent and an interventional tool using a multi-energy computed tomography (MECT) system is provided. The method includes introducing a contrast agent into a first vessel, introducing an interventional tool through a second vessel into an area of interest in flow communication with the first vessel, acquiring a plurality of projection data of an area of interest in flow communication with the first vessel and the second vessel, and decomposing the projection data into a first density map representative of the contrast agent and a second density map representative of the interventional tool.

In still another aspect, a multi-energy computed tomography (MECT) system is provided. The MECT system includes at least one radiation source, at least one radiation detector, and a computer coupled to the radiation source and the radiation detector. The computer is configured to introduce a first contrast agent into a first vessel, introduce a second contrast agent into a second vessel, said first contrast agent different than said second contrast agent, said first vessel different than said second vessel, acquire a plurality of projection data of an area of interest in flow communication with the first vessel and the second vessel, and decompose the projection data into a first density map representative of the first contrast agent and a second density map representative of the second contrast agent.

### BRIEF DESCRIPTION OF THE DRAWINGS

FIG. 1 is a pictorial view of a MECT imaging system.

FIG. 2 is a block schematic diagram of the system illustrated in FIG. 1.

FIG. 3 is an exemplary arterial system that can be imaged using the methods described herein.

FIG. 4 is another exemplary arterial system that is imaged using the methods as described herein.

FIG. 5 is a schematic illustration of a method for discriminating multiple contrast agents in a patient.

FIG. 6 is a flow chart representing a pre-reconstruction analysis.

FIG. 7 is a flow chart representing a post-reconstruction analysis.

FIG. 8 is a graphical representation of a total attenuation of three contrast agents.

FIG. 9 is an exemplary embodiment of a method for discriminating between a contrast agent and an interventional tool using the MECT system shown in FIG. 1.

FIG. 10 is a graphical representation of a total attenuation of iodine, gadolinium, stainless steel, stainless steel with a gold coating, and Nitinol.

### DETAILED DESCRIPTION OF THE INVENTION

The methods and apparatus described herein address simultaneously acquiring images of two contrast agents within a patient, and displaying the results to an observer for the purpose of discriminating two or more objects, discriminating two or more contrast agent-filled spaces, and/or simultaneously observing two components of a process, as in, for example, but not limited to, mixing of collateral blood flow. Additionally, the methods described herein are used to characterize the state of collateral blood circulation, enable simultaneous imaging of the blood supply and other vasculature of an organ, such as, vasculature and the mammary ducts within a breast, or the vasculature and the gastrointestinal lumen, and simultaneously display a liquid contrast agent filling a vessel, and the tip of the injecting catheter. The methods and apparatus described herein are described as applied to CT imaging. However, the methods also can be applied to radiographic x-ray imaging, digital mammography, and fluoroscopic projection x-ray imaging. Additionally, the ability to acquire images rapidly in fluoroscopic mode, may facilitate the adoption of the interventional applications.

Additionally, the methods described herein include novel approaches to make use of the basic properties of the x-ray and material interaction. For example, for each ray trajectory, multiple measurements with different mean x-ray energies are acquired. When Compton and photoelectric decomposition and/or BMD are performed on these measurements, additional information is obtained that enables improved accuracy and characterization. Through an appropriate choice of contrast agents, the concentration of the first agent can be imaged separately from the second contrast agent, even if the total projected attenuation in the two views is similar. Simultaneous imaging of multiple contrast agents facilitates visualization of collateral blood flow, simultaneous imaging of lymphatic and vascular vessels, visualization of catheter tips or stents in a relatively radiopaque contrast filled vessel, and differentiation of multiple stents in a single image or projection.

In some known CT imaging system configurations, an x-ray source projects a fan-shaped beam which is collimated to lie within an x-y plane of a Cartesian coordinate system and generally referred to as an “imaging plane”. The x-ray beam passes through an object being imaged, such as a patient. The beam, after being attenuated by the object, impinges upon an array of radiation detectors. The intensity of the attenuated radiation beam received at the detector array is dependent upon the attenuation of an x-ray beam by the object. Each detector element of the array produces a separate electrical signal that is a measurement of the beam intensity at the detector location. The intensity measurements from all the detectors are acquired separately to produce a transmission profile.

In third generation CT systems, the x-ray source and the detector array are rotated with a gantry within the imaging plane and around the object to be imaged such that the angle at which the x-ray beam intersects the object constantly changes. A group of x-ray attenuation measurements, i.e., projection data, from the detector array at one gantry angle is referred to as a “view”. A “scan” of the object comprises a set of views made at different gantry angles, or view angles, during one revolution of the x-ray source and detector.

In an axial scan, the projection data is processed to construct an image that corresponds to a two-dimensional slice taken through the object. One method for reconstructing an image from a set of projection data is referred to in the art as the filtered backprojection technique. This process converts the attenuation measurements from a scan into integers called “CT numbers” or “Hounsfield units” (HU), which are used to control the brightness of a corresponding pixel on a cathode ray tube display.

To reduce the total scan time, a “helical” scan may be performed. To perform a “helical” scan, the patient is moved while the data for the prescribed number of slices is acquired. Such a system generates a single helix from a fan beam helical scan. The helix mapped out by the fan beam yields projection data from which images in each prescribed slice may be reconstructed.

Reconstruction algorithms for helical scanning typically use helical weighing algorithms that weight the collected data as a function of view angle and detector channel index. Specifically, prior to a filtered backprojection process, the data is weighted according to a helical weighing factor, which is a function of both the gantry angle and detector angle. The weighted data is then processed to generate CT numbers and to construct an image that corresponds to a two-dimensional slice taken through the object.

To further reduce the total acquisition time, multi-slice CT has been introduced. In multi-slice CT, multiple rows of projection data are acquired simultaneously at any time instant. When combined with helical scan mode, the system generates a single helix of cone beam projection data. Similar to the single slice helical, weighting scheme, a method can be derived to multiply the weight with the projection data prior to the filtered backprojection algorithm.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Also as used herein, the phrase “reconstructing an image” is not intended to exclude embodiments of the present invention in which data representing an image is generated but a viewable image is not. However, many embodiments generate (or are configured to generate) at least one viewable image.

Herein are described methods and apparatus for discriminating multiple contrast agents using an energy-discriminating (also known as multi-energy) computed tomography (MECT) system. First described is MECT system 10 and followed by contrast applications using MECT system 10.

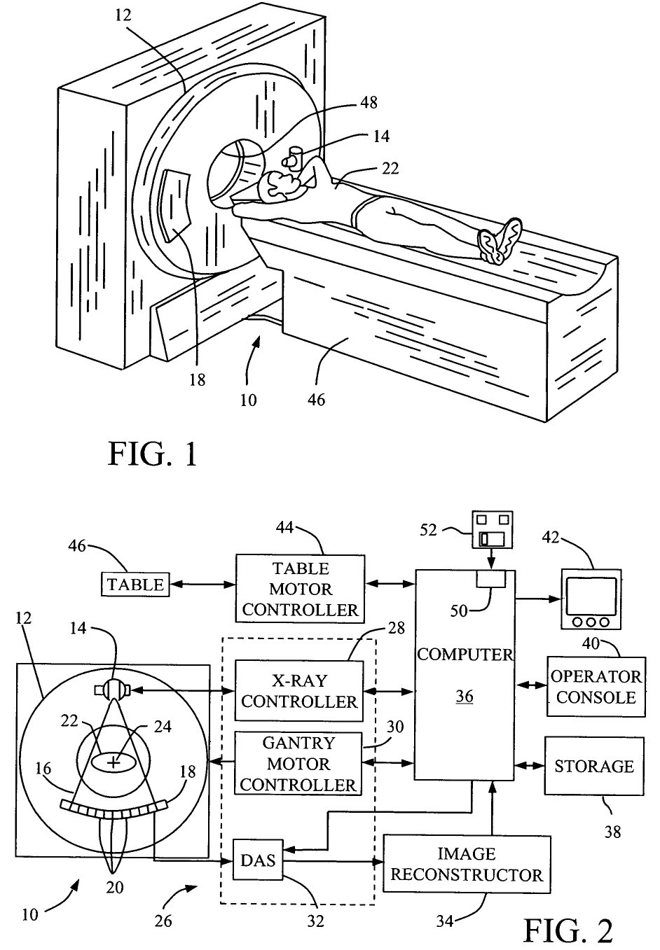

Referring to FIGS. 1 and 2, a multi-energy scanning imaging system, for example, a multi-energy multi-slice computed tomography (MECT) imaging system 10, is shown as including a gantry 12 representative of a “third generation” CT imaging system. As used herein, a multi-energy computed tomography system may also be referred to as an energy discrimination CT (EDCT) system. Gantry 12 has an x-ray source 14 that projects a beam of x-rays 16 toward a detector array 18 on the opposite side of gantry 12. Detector array 18 is formed by a plurality of detector rows (not shown) including a plurality of detector elements 20 which together sense the projected x-rays that pass through an object, such as a medical patient 22. Each detector element 20 produces an electrical signal that represents the intensity of an impinging x-ray beam and hence can be used to estimate the attenuation of the beam as it passes through object or patient 22. During a scan to acquire x-ray projection data, gantry 12 and the components mounted therein rotate about a center of rotation 24. FIG. 2 shows only a single row of detector elements 20 (i.e., a detector row). However, multi-slice detector array 18 includes a plurality of parallel detector rows of detector elements 20 such that projection data corresponding to a plurality of quasi-parallel or parallel slices can be acquired simultaneously during a scan.

Rotation of components on gantry 12 and the operation of x-ray source 14 are governed by a control mechanism 26 of MECT system 10. Control mechanism 26 includes an x-ray controller 28 that provides power and timing signals to x-ray source 14 and a gantry motor controller 30 that controls the rotational speed and position of components on gantry 12. A data acquisition system (DAS) 32 in control mechanism 26 samples analog data from detector elements 20 and converts the data to digital signals for subsequent processing. An image reconstructor 34 receives sampled and digitized x-ray data from DAS 32 and performs high-speed image reconstruction. The reconstructed image is applied as an input to a computer 36, which stores the image in a storage device 38. Image reconstructor 34 can be specialized hardware or computer programs executing on computer 36.

Computer 36 also receives commands and scanning parameters from an operator via console 40 that has a keyboard. An associated cathode ray tube display 42 allows the operator to observe the reconstructed image and other data from computer 36. The operator supplied commands and parameters are used by computer 36 to provide control signals and information to DAS 32, x-ray controller 28, and gantry motor controller 30. In addition, computer 36 operates a table motor controller 44, which controls a motorized table 46 to position patient 22 in gantry 12. Particularly, table 46 moves portions of patient 22 through gantry opening 48.

In one embodiment, computer 36 includes a device 50, for example, a floppy disk drive, CD-ROM drive, DVD drive, magnetic optical disk (MOD) device, or any other digital device including a network connecting device such as an Ethernet device for reading instructions and/or data from a computer-readable medium 52, such as a floppy disk, a CD-ROM, a DVD, a MOD or an other digital source such as a network or the Internet, as well as yet to be developed digital means. Computer 36 is programmed to perform functions described herein, and as used herein, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein. CT imaging system 10 is an energy-discriminating (also known as multi-energy) computed tomography (MECT) system in that system 10 is configured to be responsive to different x-ray spectra. This can be accomplished with a conventional third generation CT system to acquire projections sequentially at different x-ray tube potentials. For example, two scans are acquired either back to back or interleaved in which the tube operates at 80 kVp and 160 kVp potentials, for example. Alternatively, special filters are placed between the x-ray source and the detector such that different detector rows collect projections of different x-ray energy spectrum. Alternatively, the special filters that shape the x-ray spectrum can be used for two scans that are acquired either back to back or interleaved. Yet another embodiment is to use energy sensitive detectors such that each x-ray photon reaching the detector is recorded with its photon energy. Although the specific embodiment mentioned above refers to a third generation CT system, the methods described herein equally apply to fourth generation CT systems (stationary detector—rotating x-ray source) and fifth generation CT systems (stationary detector and x-ray source).

There are different methods to obtain multi-energy measurements: (1) scan with two distinctive energy spectra, (2) detect photon energy according to energy deposition in the detector, and (3) photon counting. Photon counting provides clean spectra separation and an adjustable energy separation point for balancing photon statistics.

MECT facilitates reducing or eliminating a plurality of problems associated with conventional CT, such as, but not limited to, a lack of energy discrimination and material characterization. In the absence of object scatter, one only need system 10 to separately detect two regions of photon energy spectrum: the low-energy and the high-energy portions of the incident x-ray spectrum. The behavior at any other energy can be derived based on the signal from the two energy regions. This phenomenon is driven by the fundamental fact that in the energy region where medical CT is interested, two physical processes dominate the x-ray attenuation: (1) Compton scatter and the (2) photoelectric effect. Thus, detected signals from two energy regions provide sufficient information to resolve the energy dependence of the material being imaged. Furthermore, detected signals from two energy regions provide sufficient information to determine the relative composition of an object composed of two materials.

In an exemplary embodiment, MECT uses a decomposition algorithm, such as, but not limited to, a CT number difference algorithm, a Compton and photoelectric decomposition algorithm, a basis material decomposition (BMD) algorithm, and a logarithm subtraction decomposition (LSD) algorithm.

The CT number difference algorithm includes calculating a difference value in a CT or a Hounsfield number between two images obtained at different tube potentials. In one embodiment, the difference values are calculated on a pixel-by-pixel basis. In another embodiment, average CT number differences are calculated over a region of interest. The Compton and photoelectric decomposition algorithm includes acquiring a pair of images using MECT 10, and separately representing the attenuations from Compton and photoelectric processes. The BMD algorithm includes acquiring two CT images, wherein each image represents the equivalent density of one of the basis materials. Since a material density is independent of x-ray photon energy, these images are approximately free of beam-hardening artifacts. Additionally, an operator can choose the basis material to target a certain material of interest, thus enhancing the image contrast. In use, the BMD algorithm is based on the concept that the x-ray attenuation (in the energy region for medical CT) of any given material can be represented by proper density mix of other two given materials, accordingly, these two materials are called the basis materials. In one embodiment, using the LSD algorithm, the images are acquired with quasi-monoenergetic x-ray spectra, and the imaged object can be characterized by an effective attenuation coefficient for each of the two materials, therefore the LSD algorithm does not incorporate beam-hardening corrections. Additionally, the LSD algorithm is not calibrated, but uses a determination of the tissue cancellation parameters, which are the ratio of the effective attenuation coefficient of a given material at the average energy of each exposure. In an exemplary embodiment, the tissue cancellation parameter is primarily dependent upon the spectra used to acquire the images, and on any additional factors that change the measured signal intensity from that which would be expected for a pair of ideal, mono-energetic exposures.

It should be noted that in order to optimize a multi-energy CT system, the larger the spectra separation, the better the image quality. Also, the photon statistics in these two energy regions should be similar, otherwise, the poorer statistical region will dominate the image noise.

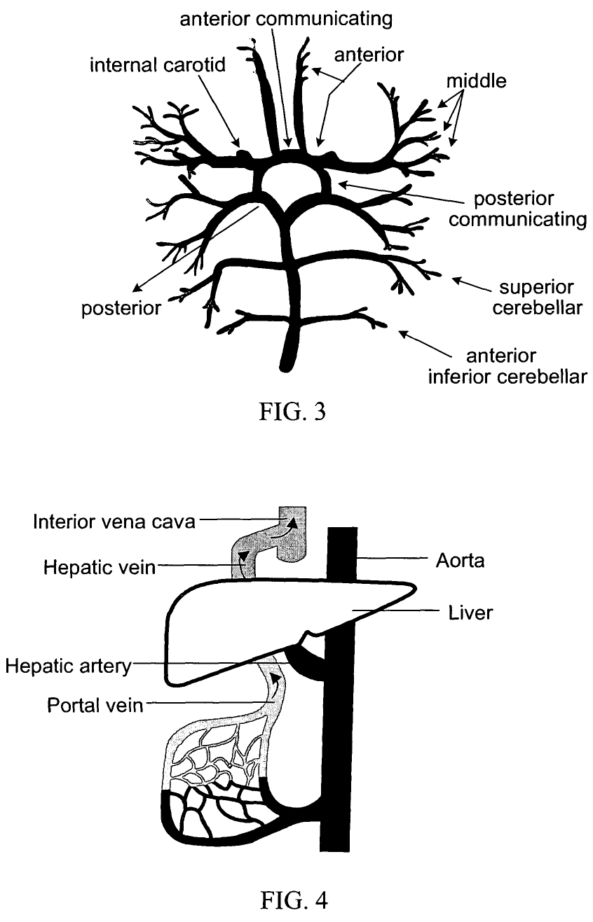

FIG. 3 is an exemplary arterial system that can be imaged using the methods described herein. For example, as shown in FIG. 3, a Circle of Willis in a brain is a loop of blood vessels along the undersurface of the brain between the brain and the skull base. Oxygenated blood enters the circle from both the right and left carotid arteries. The blood travels around the Circle of Willis, mixes, and is distributed to the brain through the cerebral arteries. Due to the turbulent flow, the Circle of Willis is a common site for aneurysms, typically forming at the junctions with other arteries.

FIG. 4 is another exemplary arterial system that is imaged using the methods as described herein. For example, as shown in FIG. 4, a hepatic circulation system includes a liver, a small hepatic artery that branches off a coeliac artery that delivers oxygenated arterial blood to the liver. However, most of the blood flowing through the liver comes from the gut via the coeliac artery, the anterior mesenteric artery, and the posterior mesenteric artery that feed into the large hepatic portal vein. Both the oxygen perfusing arterial-venous circulation and the portal circulation are imaged using these methods, and the liver perfusion discriminated. In this way, effective diagnosis of perfusion mismatches between portal and arterial circulation is determined and accurate overall liver function assessed.

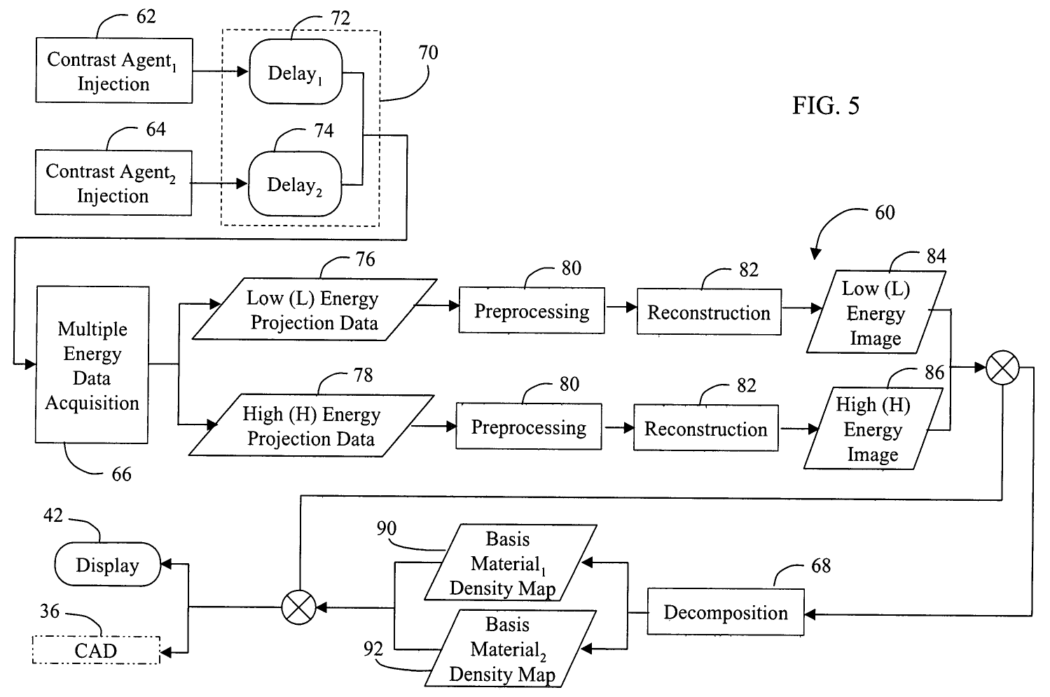

FIG. 5 is a schematic illustration of a method 60 for discriminating multiple contrast agents in a patient 22 (shown in FIG. 1) using the medical imaging system illustrated in FIG. 1. Method 60 includes introducing 62 a first contrast agent into a first vessel, such as, but not limited to, an artery or a vein, introducing 64 a second contrast agent into a second vessel, such as, but not limited to, an artery or a vein, the first contrast agent different than the second contrast agent, the first vessel different than the second vessel, acquiring 66 a plurality of projection data of a region of interest in flow communication with the first vessel and the second vessel, and decomposing 68 the projection data into a first density map representative of the first contrast agent and a second density map representative of the second contrast agent.

In use, two catheters are inserted into the arterial vessels upstream of the tissue that has the collateral circulation, for example, into the left and right carotid arteries of patient 22. A first contrast agent is injected into the first artery using the first catheter, and a second contrast agent, different than the first contrast agent, is injected into a second artery different than the first artery, using a second catheter. In one embodiment, the first contrast agent includes, but is not limited to a chelate of gadolinium such as Gd-DTPA, or a non-ionic chelate such as gadodiamide (gadolinium-diethylenetriamine penta-acetic acid bismethylamide, C₁₆H₂₈GdN₅O₉xH₂O). The second contrast agent includes, but is not limited to, an ionic or non-ionic iodine-based agent such as Iopamidol.

Acquiring 66 a plurality of projection data of the region of interest includes acquiring a plurality of projection data after a time delay 70. In one embodiment, time delay 70 includes a first delay 72 and a second delay 74. Time delay, as used herein, represents a length of time that an operator waits to enable the contrast agent to flow to the region of interest. In one embodiment, first delay 72 is approximately equal to second delay 74. In another embodiment, first delay 72 is not approximately equal to second delay 74. In one embodiment, the first contrast agent and the second contrast agent are either automatically or manually injected approximately simultaneously into the first artery and the second artery, respectively. In another embodiment, the methods described herein can be accomplished in two stages, injecting the first artery with the first contrast agent and acquiring an image of the first artery, and then injecting the second artery with the second contrast agent and acquiring an image of the second artery. In an exemplary embodiment, the plurality of projection data includes a plurality of low energy projection data 76 and a plurality of high energy projection data 78, wherein high energy projection data 78 is generated using a radiation energy that is greater than a radiation energy used to acquire low energy projection data 76.

Method 60 also includes preprocessing 80 and reconstructing 82 low energy projection data 76 and high energy projection data 78 to generate at least one low energy image 84 and at least one high energy image 86. In one embodiment, low energy image 84 and high energy image 86 are decomposed 68 using a decomposition algorithm, such as, but not limited to, a CT number difference algorithm, a Compton and photoelectric decomposition algorithm, a basis material decomposition (BMD) algorithm, and a logarithm subtraction decomposition (LSD) algorithm to generate a first density map 90 representative of the first contrast agent and a second density map 92 representative of the second contrast agent. In an alternative embodiment, low energy projection data 76 and high energy projection data 78 are decomposed prior to reconstructing first density map 90 and second density map 92. First density map 90 and second density map 92 are then displayed on display 42 using computer 36.

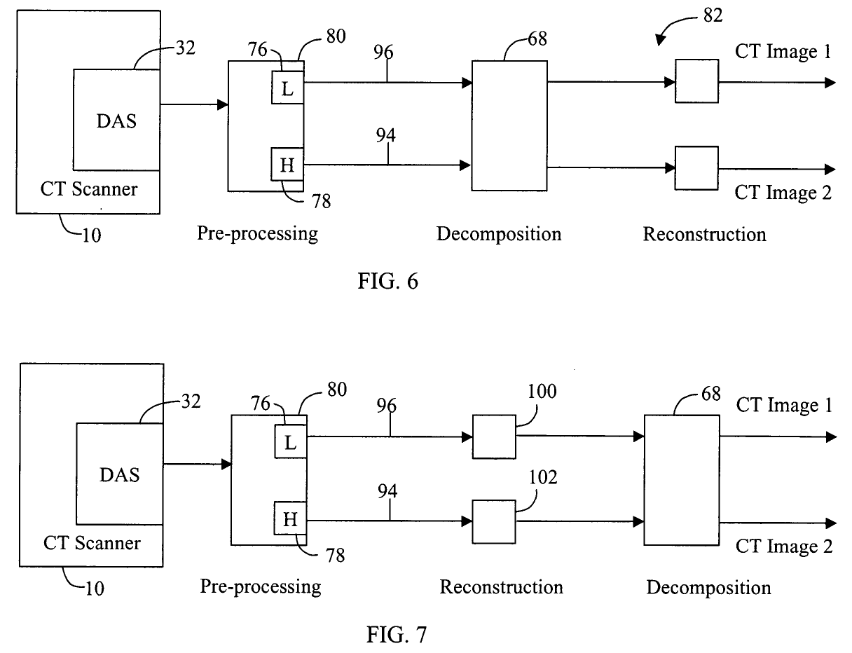

FIG. 6 is a flow chart representing a pre-reconstruction analysis wherein decomposition 68 is accomplished prior to reconstruction 82. Computer 36 collects the acquired projection data generated by detector array 18 (shown in FIG. 1) at discrete angular positions of the rotating gantry 12 (shown in FIG. 1), and passes the signals to preprocessor 80. Preprocessor 80 resorts the projection data received from computer 36 to optimize the sequence for the subsequent mathematical processing. Preprocessor 80 also corrects the projection data from computer 36 for detector temperature, intensity of the primary beam, gain and offset, and other deterministic error factors. Preprocessor 80 then extracts data corresponding to high-energy views 84 and routes it to a high energy channel path 94, and routes the data corresponding to low-energy views 86 to a low energy path 96. Using the high energy data 78 and low energy data 76, a basis material decomposition algorithm can be used to produce two streams of projection data, which are then reconstructed to obtain two individual images pertaining to two different materials.

FIG. 7 is a flow chart representing a post-reconstruction analysis wherein decomposition 68 is accomplished after reconstruction 82. Computer 36 collects the acquired projection data generated by detector array 18 (shown in FIG. 1) at discrete angular positions of rotating gantry 12 (shown in FIG. 1), and routes the data corresponding to high-energy views 78 to high energy path 94 and routes the data corresponding to low-energy views 76 to low energy path 96. A first CT image 100 corresponding to the high-energy series of projections 78 and a second CT image 102 corresponding to low-energy series of projections 76 are produced. Dual-energy decomposition 68 is then performed using a decomposition algorithm to obtain two individual images 90 and 92, respectively, pertaining to two different materials. In another embodiment, performing a scout image analysis, the signal flow is similar to FIG. 6 or 7, however, table 46 (shown in FIG. 1) is moved relative to non-rotating gantry 12 (shown in FIG. 1) to acquire the data.

In an exemplary embodiment, first density map 90 and second density map 92 are color-coded as overlays on a conventional grayscale display of the Hounsfield number data, or the observer can toggle between data sets, or toggle the overlay of the datasets. In another exemplary embodiment, the image data and density map data is input to a computer-aided detection system for the detection, diagnosis, or quantification of any pathologies.

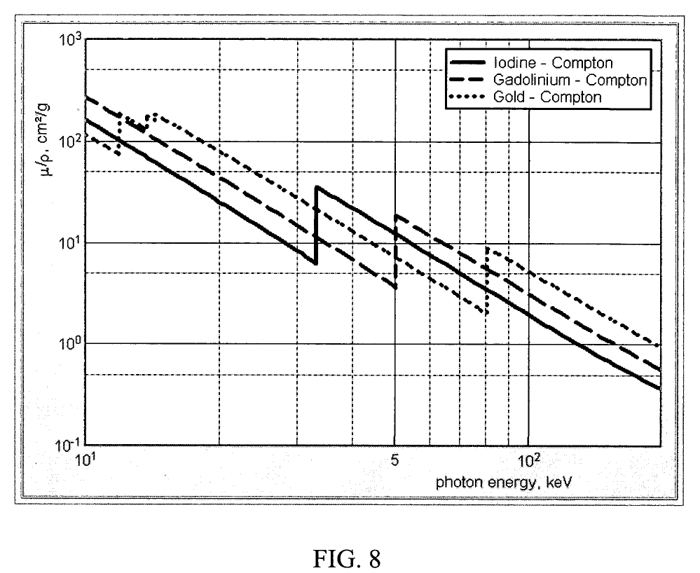

FIG. 8 is a graphical representation of a total attenuation of three contrast agents, iodine, gadolinium and gold, showing the energy dependent difference in attenuation and attenuation reversals. In an exemplary embodiment, at low energies, i.e. between approximately 33 kiloelectron volts (keV) and approximately 80 keV, iodine is more attenuating, whereas at higher energies, greater than approximately 80 keV, gold is more attenuating on a per atom basis.

In use, the methods described herein facilitates enabling new clinical applications for both CT and X-ray radiography and fluoroscopy for a variety of disease conditions, and facilitates improving the efficacy of the diagnosis, staging, and monitoring of Crohn's and other gastrointestinal (GI) diseases. Additionally, the methods described herein facilitate an increase in the utility of vascular CT imaging, offers the potential development of many new x-ray vascular and GI fluoroscopic procedures, adds a new type of information that can be acquired by CT or x-ray imaging, offers the potential for greater use of CT and X-ray in molecular imaging applications through more accurate imaging of targeted contrast agents, and facilitates increasing the potential to open new medical markets for both CT and X-ray applications, and may enable the development of new more specific contrast agents and devices.

In use, method 60 facilitates imaging of collateral blood flow to the brain through the Circle of Willis with dual arterial contrast agent injection, imaging of the complete hepatic circulation including the small hepatic artery which branches off the coeliac artery and delivers oxygenated arterial blood to the organ, imaging the anterior mesenteric artery and the posterior mesenteric artery which feed into the large hepatic portal vein. Additionally, both the oxygen perfusing arterial-venous circulation and the portal circulation can be imaged using the methods described herein, and the liver perfusion discriminated. Accordingly, method 60 facilitates increasing an effectiveness of a diagnosis of perfusion mismatches between portal and arterial circulation, and therefore an assessment of an overall liver function.

Additionally, method 60 facilitates providing an assessment of organ viability prior to or following a transplant, such as, but not limited to, a liver transplant, in which the portal and arterial circulation perfusion should match for healthy function, and also facilitates evaluating the perfusion and function of the organ before and/or after transplantation. Method 60 is also used to image the arterial-venous circulation and the mammary ductal pattern in the breast, using at least one of a projection x-ray mammography or standard CT geometry, with the patient lying supine on an examination table or on a dedicated breast CT system.

Method 60 also facilitates discriminating between multiple contrast agents wherein a first contrast agent includes a nanoparticle or microsphere contrast agent, in which the contrast agent is the shell of the particle itself, such as, but not limited to gold, or a Lanthanide element, or contained within the nanoparticle shell. In use, the nanoparticle may or may not be conjugated to a biologically relevant molecule to enable ‘targeted’ delivery and uptake of the agent.

The methods described herein may also be used as a technique to replace some dual-isotope imaging procedures currently performed using single photon computed tomography (SPECT) imaging devices, for example, the detection and localization of liver tumors currently performed with gallium (Ga) and technicium (Tc) dual isotope SPECT imaging. The methods can also be used as a technique to simultaneously image the gastro-intestinal track and vasculature, for example, using barium sulphate as a GI contrast agent, and iodine or gadolinium based vascular agents. Given the suboptimal attenuation differences between barium and iodine or gadolinium, other chemical agent pairs may produce better results, thereby providing a benefit in the management and staging of Crohn's disease.

Accordingly, for contrast agents that include sufficiently different x-ray attenuation properties, i.e., a variation in photo-electric and a variation in Compton cross-section, MECT system 10 can effectively discriminate between the two contrast agents using the decomposition and reconstruction techniques described herein, therefore enabling the acquisition of image data sets that include a quantitative map of the distribution of one of the contrast agents.

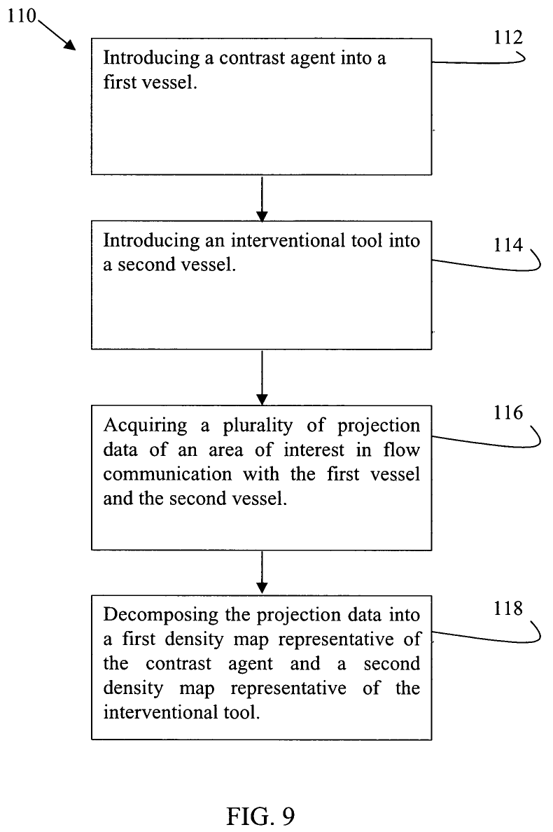

FIG. 9 is an exemplary embodiment of a method 110 for discriminating between a contrast agent and an interventional tool using MECT system 10, wherein method 110 includes introducing 112 a contrast agent into a first vessel, and introducing 114 an interventional tool into a second vessel. In one embodiment, the first vessel is the same as the second vessel. In another embodiment, the first vessel is different than the second vessel. Method 110 also includes acquiring 116 a plurality of projection data of an area of interest in flow communication with the first vessel and the second vessel, and decomposing 118 the projection data into a first density map representative of the contrast agent and a second density map representative of the interventional tool. In an exemplary embodiment, the interventional tool includes, but is not limited to, a catheter, a stent, an orthopedic device, or a surgical device.

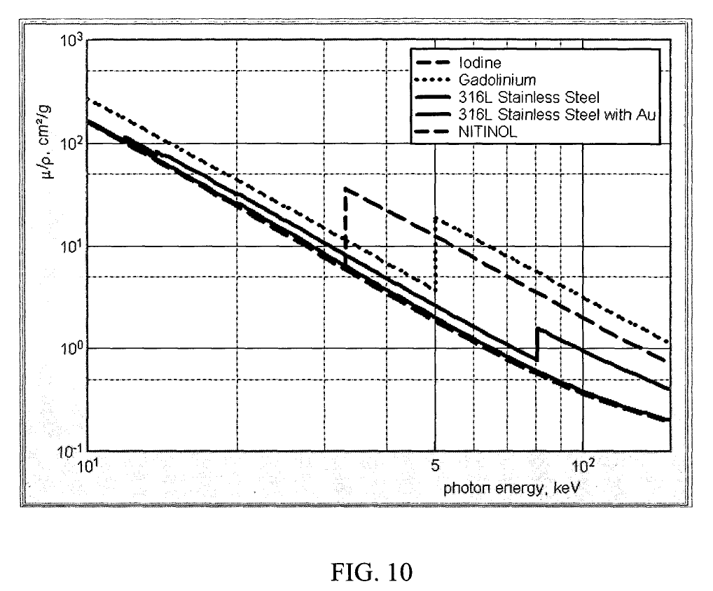

FIG. 10 is a graphical representation of a total attenuation of iodine, gadolinium, stainless steel, stainless steel with a gold coating (0.2% Au by composition) and Nitinol. As shown, FIG. 10 illustrates the energy dependent difference in attenuation between a stainless steel stent coated with gold and conventional stainless steel and Nitinol stents and contrast agents. Additionally, the k-edge absorption of gold can be exploited to differentiate gold-plated-stainless from both unplated stainless and Nitinol stents, and all of the stent compositions can be differentiated from the intravascular contrast agents.

In use, method 110 facilitates discriminating between an injected or ingested contrast agent, such as, but not limited to, Iopamidol, and an interventional tool or part of the interventional tool, such as a catheter, which is fabricated from a material that is sufficiently different in atomic number or photoelectric and Compton x-ray cross section. For example, using method 110, an interventionalist can discriminate between the catheter tip and the injected contrast agent even though they may have similar Hounsfield numbers, and may be obscured by other artifacts, or a volume projection may prevent visual discrimination.

Method 110 provides the following advantages. Method 110 is used to discriminate between an injected contrast agent and an implanted intravascular device such as a stent or aneurysm coil. For example, a common stent is fabricated from Nitinol, an alloy of nearly equal mixtures of nickel and titanium. Additionally, many medical device alloys include approximately 55.6% nickel, and the remainder titanium. As shown in FIG. 10, Iodine and Nitinol include approximately identical attenuation properties below the k-edge of iodine, and dramatically different attenuation above the Iodine k-edge. Additionally, Nitinol devices have radiopacity that is comparable to stainless steel for similar objects of similar mass and dimension. Stainless steel devices can be plated with gold other radiopaque materials to enhance their radiopacity. However, the elastic and mechanical properties of Nitinol are degraded with these coatings. Accordingly, the radiopacity of Nitinol devices can be problematic, and the low attenuation problem is exacerbated when a highly attenuating material such as iodinated contrast agent surrounds the device. Therefore, the methods described herein facilitate discriminating the iodine, or other injected contrast agent, from the properties of the implanted device.

In at least one known vascular procedure, the length of a stenosis is longer than that which can be covered by a single stent. In these cases, multiple contiguous stent placements are used. To ensure complete coverage of the pathology, the stents must overlap in these procedures, however excessive overlap will increase the rigidity of the vessel and impair hemodynamic function, which is a common cause of morbidity in these procedures. Accordingly, method 110 also facilitates discriminating between two stents and accurately viewing their displacement relative to each other. In use, the stents are fabricated from alloys that include elements with different x-ray cross-sections to enable adequate energy separation, such as, but not limited to, Nitinol or stainless steel stents and gold-plated stainless steel stents, as shown in FIG. 10.

Method 110 is also used to distinguish between an injected contrast, a natural bone or soft tissue contrast, and an x-ray detectable surgical device, such as, but not limited to, barium sulphate gauze sponges or stainless steel devices.

In use, the display of tissue characterization data is performed in a plurality of methods. For example, using a grayscale display to depict the morphological characteristics of the imaged anatomy, wherein the grayscale value is linked to the CT number through an appropriate look-up-table. This morphological component of the displayed data is chosen from any one of the MECT image datasets, or a combination of two or more datasets. Additionally, color overlays that are indicative of the amount of a given contrast agent in the voxel or projection, such as, but not limited to, a red color scale indicating iodine concentration and a blue scale representing the gadolinium concentration, are superimposed upon this morphological data. Additionally, images showing contrast agent and devices such as Nitinol stents include color scales and/or temporal variation in pixel intensities, i.e. blinking or flashing, are displayed. An operator can therefore toggle between the views: anatomic, characteristic material one, and characteristic material two, or toggle the addition of the overlays, via software switch(es).

While the invention has been described in terms of various specific embodiments, those skilled in the art will recognize that the invention can be practiced with modification within the spirit and scope of the claims.

What is claimed is:

1. A method for discriminating multiple contrast agents using a medical imaging system, said method comprising:
introducing a first contrast agent into a first vessel;
introducing a second contrast agent different from the first contrast agent into a second vessel different from the first vessel;
acquiring a plurality of projection data of an area of interest in flow communication with the first vessel and the second vessel; and
decomposing the projection data into a first density map representative of the first contrast agent and a second density map representative of the second contrast agent.

2. A method in accordance with claim 1 wherein said acquiring a plurality of projection data comprises acquiring a plurality of projection data using a multi-energy computed tomographic (MECT) imaging system.

3. A method in accordance with claim 1 wherein said acquiring a plurality of projection data comprises acquiring a plurality of projection data using at least one of a digital mammographic imaging system, a radiographic imaging system, and a fluoroscopic imaging system.

4. A method in accordance with claim 1 wherein said decomposing the projection data comprises decomposing the projection data using at least one of a CT number difference algorithm, a Compton and photoelectric decomposition algorithm, a basis material decomposition (BMD) algorithm, and a logarithm subtraction decomposition (LSD) algorithm.

5. A method for discriminating multiple contrast agents using a medical imaging system, said method comprising;
introducing a first contrast agent into a first vessel;
introducing a second contrast agent into a second vessel, the first contrast agent different than the second contrast agent, the first vessel different than the second vessel;
acquiring a plurality of projection data of an area of interest in flow communication with the first vessel and the second vessel using a multi-energy computed tomographic (MECT) imaging system; and
decomposing the projection data into a first density map representative of the first contrast agent and a second density map representative of the second contrast agent using the MECT imaging system.

6. A method in accordance with claim 5 wherein said introducing a first contrast agent into a first vessel and said introducing a second contrast agent into a second vessel comprises introducing a first contrast agent into a first artery and introducing a second contrast agent into a second artery.

7. A method in accordance with claim 5 wherein said decomposing the projection data comprises decomposing the projection data using at least one of a CT number difference algorithm, a Compton and photoelectric decomposition algorithm, a basis material decomposition (BMD) algorithm, and a logarithm subtraction decomposition (LSD) algorithm.

8. A method in accordance with claim 5 wherein said introducing a first contrast agent into a first vessel comprises introducing a gadolinium-based agent into a first vessel.

9. A method in accordance with claim 5 wherein said introducing a second contrast agent into a second vessel comprises introducing an iodine-based agent into a second vessel.

10. A method in accordance with claim 5 wherein said acquiring a plurality of projection data of an area of interest in flow communication with the first vessel and the second vessel comprises acquiring a plurality of low energy projection data at a first radiation energy and acquiring a plurality of high energy projection data at a second radiation energy, the second radiation energy greater than the first radiation energy.

11. A method in accordance with claim 10 further comprising preprocessing and reconstructing the low energy projection data to generate at least one low energy image, and preprocessing and reconstructing the high energy projection data to generate at least one high energy image.

12. A method in accordance with claim 11 wherein said preprocessing the low energy projection data and the high energy projection data comprises correcting the low energy projection data and the high energy projection data for at least one of a detector temperature, a beam intensity, a detector gain, and a detector offset.

13. A method for discriminating between a contrast agent and an interventional tool using a medical imaging system comprises:
introducing a contrast agent into a first vessel;
introducing an interventional tool into a second vessel;
acquiring a plurality of projection data of an area of interest in flow communication with the first vessel and the second vessel; and
decomposing the projection data into a first density map representative of the contrast agent and a second density map representative of the interventional tool.

14. A method in accordance with claim 13 wherein said acquiring a plurality of projection data comprises acquiring a plurality of projection data using at least one of a MECT, a digital mammographic imaging system, a radiographic imaging system, and a fluoroscopic imaging system.

15. A method in accordance with claim 13 wherein said introducing an interventional tool into a second vessel comprises introducing an interventional tool into a second vessel, the second vessel different than the first vessel.

16. A method in accordance with claim 13 wherein said introducing an interventional tool into a second vessel comprises introducing at least one of a stent, a catheter, an orthopedic device, and a surgical device into a second vessel.

17. A method for discriminating multiple contrast agents using a MECT system, said method comprising;
introducing a first contrast agent into a first vessel;
introducing a second contrast agent into a second vessel, said first contrast agent different than said second contrast agent, said first vessel different than said second vessel;
acquiring a plurality of projection data, using a multi-energy computed tomographic (MECT) imaging system, of an area of interest in flow communication with the first vessel and the second vessel; and
decomposing the projection using at least one of a CT number difference algorithm, a Compton and photoelectric decomposition algorithm, a basis material decomposition (BMD) algorithm, and a logarithm subtraction decomposition (LSD) algorithm, into a first density map representative of the first contrast agent and a second density map representative of the second contrast agent.

18. A multi-energy computed tomography (MECT) system comprising:
at least one radiation source;
at least one radiation detector; and
a computer coupled to said radiation source and said radiation detector, said computer configured to:
acquire a plurality of projection data of an area of interest in flow communication with a first vessel and a second vessel; and
decompose the projection data into a first density map representative of a first contrast agent introduced into the first vessel and a second density map representative of a second contrast agent introduced into the second vessel.

19. A MECT system in accordance with claim 18 wherein said computer is further configured to introduce a first contrast agent into a first artery and introduce a second contrast agent into a second artery, said first contrast agent different than said second contrast agent, said first artery different than said second artery.

20. A MECT system in accordance with claim 18 wherein said computer is further configured to decompose the projection data using at least one of a CT number difference algorithm, a Compton and photoelectric decomposition algorithm, a basis material decomposition (BMD) algorithm, and a logarithm subtraction decomposition (LSD) algorithm.

21. A MECT system in accordance with claim 18 wherein said computer is further configured to introduce a gadolinium-based agent into a first vessel.

22. A MECT system in accordance with claim 18 wherein said computer is further configured to introduce an iodine-based agent into a second vessel.

23. A MECT system in accordance with claim 18 wherein said computer is further configured to acquire a plurality of low energy projection data at a first radiation energy and acquiring a plurality of high energy projection data at a second radiation energy, the second radiation energy greater than the first radiation energy.

24. A MECT system in accordance with claim 23 wherein said computer is further configured to preprocess and reconstruct the low energy projection data to generate at least one low energy image, and preprocess and reconstruct the high energy projection data to generate at least one high energy image.

25. A MECT system in accordance with claim 24 wherein said computer is further configured to correct the low energy projection data and the high energy projection data for at least one of a detector temperature, a beam intensity, a detector gain, and a detector offset.
